(19) United States
(12) Patent Application Publication
(10) Pub. No.: US 2026/0051258 A1
(43) Pub. Date: Feb. 19, 2026

(54) SYSTEMS AND METHODS FOR AIRPORT NETWORK-BASED SURFACE COLLISION AVOIDANCE

(71) Applicant: HONEYWELL INTERNATIONAL INC., Charlotte, NC (US)

(72) Inventors: Haidong Huang, Beijing (CN); Zuowei He, Shanghai (CN)

(73) Assignee: HONEYWELL INTERNATIONAL INC., Charlotte, NC (US)

(21) Appl. No.: 18/802,163

(22) Filed: Aug. 13, 2024

(51) Int. Cl. G08G 5/04; G08G 5/00

(52) U.S. Cl. CPC G08G 5/80; G08G 5/21; G08G 5/26; G08G 5/723

(57) ABSTRACT

Systems and methods are provided for airport network-based surface collision avoidance. An aircraft position is received from at least one geospatial sensor. An intruder aircraft position is received via a communication system. A ground surface network is retrieved from an aircraft moving database. The intruder aircraft position is mapped to a first ground surface pathway and the aircraft position is mapped to a second ground surface pathway. A sum of half of a wingspan of the intruder aircraft and half of a wingspan of the aircraft is compared to a distance between a first centerline of the first ground surface pathway and a second centerline of the second ground surface pathway. A potential wingtip collision alert is issued for display based on the comparison.

### TECHNICAL FIELD

The present invention generally relates to aircraft operations and more particularly relates to systems and methods for airport network-based surface collision avoidance.

### BACKGROUND

Multiple aircraft often taxi on ground surface pathways at an airport. Examples of ground surface pathways include runways and taxiways. It may be challenging for a pilot to properly assess distances between wingtips of his/her own aircraft and another aircraft in advance of the two aircraft passing each other on parallel ground surface pathways. Misjudging the distances between the wingtips could potentially lead to wingtip collisions between the aircraft.

Hence, there is a need for systems and methods for airport network-based surface collision avoidance.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, an airport network-based surface collision avoidance system includes at least one processor and at least one memory communicatively coupled to the at least one processor. The at least one memory includes instructions that upon execution by the at least one processor, cause the at least one processor to: receive aircraft data associated with an aircraft from at least one geospatial sensor of the aircraft, the aircraft data including an aircraft position; receive first intruder aircraft data associated with a first intruder aircraft via a communication system of the aircraft, the first intruder aircraft data including a first intruder aircraft position; retrieve a ground surface network from an aircraft moving database (AMDB) of the aircraft, the ground surface network including a plurality of ground surface pathways; map the first intruder aircraft position to a first ground surface pathway and the aircraft position to a second ground surface pathway, the plurality of ground surface pathways including the first and second ground surface pathways; and based on a determination that at least a portion of the first ground surface pathway is parallel to at least a portion of the second ground surface pathway: compare a sum of half of a wingspan of the first intruder aircraft and half of a wingspan of the aircraft to a distance between a first centerline of the first ground surface pathway and a second centerline of the second ground surface pathway; and issue a potential wingtip collision alert for display on a display device of the aircraft based on the comparison.

In various embodiments, an aircraft including an airport network-based surface collision avoidance system includes: at least one geospatial sensor configured to generated aircraft data associated with the aircraft; a communication system; an aircraft moving database (AMDB) including a ground surface network associated with an airport, the ground surface network including a plurality of ground surface pathways at the airport; a display device; and a controller configured to be communicatively coupled to the at least one geospatial sensor, the communication system, the AMDB; and the display device. The controller is configured to: receive first intruder aircraft data associated with a first intruder aircraft via the communication system, the first intruder aircraft data including a first intruder aircraft position; receive the aircraft data from the at least one geospatial sensor, the aircraft data including an aircraft position; retrieve the ground surface network from the AMDB; map the first intruder aircraft position to a first ground surface pathway and the aircraft position to a second ground surface pathway, the plurality of ground surface pathways including the first and second ground surface pathways; and based on a determination that at least a portion of the first ground surface pathway is parallel to at least a portion of the second ground surface pathway: compare a sum of half of a wingspan of the first intruder aircraft and half of a wingspan of the aircraft to a distance between a first centerline of the first ground surface pathway and a second centerline of the second ground surface pathway; and issue a potential wingtip collision alert for display on the display device of the aircraft based on the comparison.

In various embodiments, a method for implementing an airport network-based surface collision avoidance includes: receiving aircraft data associated with an aircraft from at least one geospatial sensor of the aircraft, the aircraft data including an aircraft position; receiving first intruder aircraft data associated with a first intruder aircraft via a communication system of the aircraft, the first intruder aircraft data including a first intruder aircraft position; retrieving a ground surface network from an aircraft moving database (AMDB) of the aircraft, the ground surface network including a plurality of ground surface pathways; mapping the first intruder aircraft position to a first ground surface pathway and the aircraft position to a second ground surface pathway, the plurality of ground surface pathways including the first and second ground surface pathways; and based on a determination that at least a portion of the first ground surface pathway is parallel to at least a portion of the second ground surface pathway: comparing a sum of half of a wingspan of the first intruder aircraft and half of a wingspan of the aircraft to a distance between a first centerline of the first ground surface pathway and a second centerline of the second ground surface pathway; and issuing a potential wingtip collision alert for display on a display device of the aircraft based on the comparison.

Furthermore, other desirable features and characteristics of systems and methods for network-based collision avoidance become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram representation of a system configured implement airport network-based collision avoidance in accordance with at least one embodiment;

FIG. 2 is a block diagram representation of an aircraft including an airport network-based surface collision avoidance system in accordance with at least one embodiment;

FIG. 3 is a flowchart representation of a method of implementing network-based surface collision avoidance in accordance with at least one embodiment; and

FIG. 4 is an exemplary diagram of an aircraft and an intruder aircraft mapped to a ground surface network of an airport in accordance with an embodiment.

### DETAILED DESCRIPTION

The following detailed description is merely exemplary in nature. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

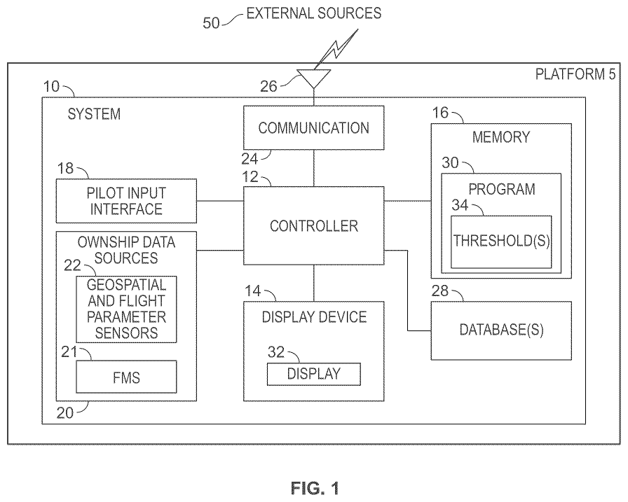

FIG. 1 is a block diagram representation of a system configured implement an airport network-based collision avoidance in accordance with at least one embodiment (shortened herein to “system” 10), as illustrated in accordance with an exemplary and non-limiting embodiment of the present disclosure. The system 10 may be utilized onboard a mobile platform 5, as described herein. In various embodiments, the mobile platform is an aircraft, which carries or is equipped with the system 10. As schematically depicted in FIG. 1, the system 10 includes the following components or subsystems, each of which may assume the form of a single device or multiple interconnected devices: a controller circuit 12 operationally coupled to: at least one display device 14; computer-readable storage media or memory 16; an optional input interface 18, and ownship data sources 20 including, for example, a flight management system (FMS) 21 and an array of flight system state and geospatial sensors 22.

In various embodiments, the system 10 may be separate from or integrated within: the flight management system (FMS) 21 and/or a flight control system (FCS). Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the mobile platform 5.

The term “controller circuit” (and its simplification, “controller”), broadly encompasses those components utilized to carry-out or otherwise support the processing functionalities of the system 10. Accordingly, the controller circuit 12 can encompass or may be associated with a programmable logic array, application specific integrated circuit or other similar firmware, as well as any number of individual processors, flight control computers, navigational equipment pieces, computer-readable memories (including or in addition to the memory 16), power supplies, storage devices, interface cards, and other standardized components. In various embodiments, the controller circuit 12 embodies one or more processors operationally coupled to data storage having stored therein at least one firmware or software program (generally, computer-readable instructions that embody an algorithm) for carrying-out the various process tasks, calculations, and control/display functions described herein. During operation, the controller circuit 12 may be programmed with and execute the at least one firmware or software program, for example, a program 30, that embodies an algorithm described herein for implementation of airport network-based surface collision avoidance in accordance with at least one embodiment on a mobile platform 5, where the mobile platform 5 is an aircraft, and to accordingly perform the various process steps, tasks, calculations, and control/display functions described herein.

The controller circuit 12 may exchange data, including real-time wireless data, with one or more external sources 50 to support operation of the system 10 in embodiments. In this case, bidirectional wireless data exchange may occur over a communications network, such as a public or private network implemented in accordance with Transmission Control Protocol/Internet Protocol architectures or other conventional protocol standards. Encryption and mutual authentication techniques may be applied, as appropriate, to ensure data security.

The memory 16 is a data storage that can encompass any number and type of storage media suitable for storing computer-readable code or instructions, such as the aforementioned software program 30, as well as other data generally supporting the operation of the system 10. The memory 16 may also store one or more threshold 34 values, for use by an algorithm embodied in software program 30. One or more database(s) 28 are another form of storage media; they may be integrated with memory 16 or separate from it.

In various embodiments, aircraft-specific parameters and information for an aircraft may be stored in the memory 16 or in a database 28 and referenced by the program 30. Non-limiting examples of aircraft-specific information includes an aircraft weight and dimensions, performance capabilities, configuration options, and the like.

Flight parameter sensors and geospatial sensors 22 supply various types of data or measurements to the controller circuit 12 during an aircraft flight. In various embodiments, the geospatial sensors 22 supply, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data.

With continued reference to FIG. 1, the display device 14 can include any number and type of image generating devices on which one or more avionic displays 32 may be produced. When the system 10 is utilized for a manned aircraft, the display device 14 may be affixed to the static structure of the Aircraft cockpit as, for example, a Head Down Display (HDD) or Head Up Display (HUD) unit. In various embodiments, the display device 14 may assume the form of a movable display device (e.g., a pilot-worn display device) or a portable display device, such as an Electronic Flight Bag (EFB), a laptop, or a tablet computer carried into the aircraft cockpit by a pilot.

At least one avionic display 32 is generated on the display device 14 during operation of the system 10; the term “avionic display” is synonymous with the term “aircraft-related display” and “cockpit display” and encompasses displays generated in textual, graphical, cartographical, and other formats. The system 10 can generate various types of lateral and vertical avionic displays 32 on which map views and symbology, text annunciations, and other graphics pertaining to flight planning are presented for a pilot to view. The display device 14 is configured to continuously render at least a lateral display showing the aircraft at its current location within the map data. The avionic display 32 generated and controlled by the system 10 can include graphical user interface (GUI) objects and alphanumerical input displays of the type commonly presented on the screens of multifunction control display units (MCDUs), as well as Control Display Units (CDUs) generally. Specifically, embodiments of the avionic displays 32 include one or more two-dimensional (2D) avionic displays, such as a horizontal (i.e., lateral) navigation display or vertical navigation display (i.e., vertical situation display VSD); and/or on one or more three dimensional (3D) avionic displays, such as a Primary Flight Display (PFD) or an exocentric 3D avionic display.

In various embodiments, a human-machine interface is implemented as an integration of a pilot input interface 18 and a display device 14. In various embodiments, the display device 14 is a touch screen display. In various embodiments, the human-machine interface also includes a separate pilot input interface 18 (such as a keyboard, cursor control device, voice input device, or the like), generally operationally coupled to the display device 14. Via various display and graphics systems processes, the controller circuit 12 may command and control a touch screen display device 14 to generate a variety of graphical user interface (GUI) objects or elements described herein, including, for example, buttons, sliders, and the like, which are used to prompt a user to interact with the human-machine interface to provide user input; and for the controller circuit 12 to activate respective functions and provide user feedback, responsive to received user input at the GUI element.

In various embodiments, the system 10 may also include a dedicated communications circuit 24 configured to provide a real-time bidirectional wired and/or wireless data exchange for the controller 12 to communicate with the external sources 50 (including, each of: traffic, air traffic control (ATC), satellite weather sources, ground stations, and the like). In various embodiments, the communications circuit 24 may include a public or private network implemented in accordance with Transmission Control Protocol/Internet Protocol architectures and/or other conventional protocol standards. Encryption and mutual authentication techniques may be applied, as appropriate, to ensure data security. In some embodiments, the communications circuit 24 is integrated within the controller circuit 12, and in other embodiments, the communications circuit 24 is external to the controller circuit 12. When the external source 50 is “traffic,” the communications circuit 24 may incorporate software and/or hardware for communication protocols as needed for traffic collision avoidance (TCAS), automatic dependent surveillance-broadcast (ADS-B), and enhanced vision systems (EVS).

In certain embodiments of the system 10, the controller circuit 12 and the other components of the system 10 may be integrated within or cooperate with any number and type of systems commonly deployed onboard an aircraft including, for example, an FMS 21.

The disclosed algorithm is embodied in a hardware program or software program (e.g. program 30 in controller circuit 12) and configured to operate when the aircraft is in any phase of flight.

In various embodiments, the provided controller circuit 12, and therefore its program 30 may incorporate the programming instructions for: receiving aircraft data associated with an aircraft from at least one geospatial sensor of the aircraft, the aircraft data including an aircraft position; receiving first intruder aircraft data associated with a first intruder aircraft via a communication system of the aircraft, the first intruder aircraft data including a first intruder aircraft position; retrieving a ground surface network from an aircraft moving database (AMDB) of the aircraft, the ground surface network including a plurality of ground surface pathways; mapping the first intruder aircraft position to a first ground surface pathway and the aircraft position to a second ground surface pathway, the plurality of ground surface pathways including the first and second ground surface pathways; and based on a determination that at least a portion of the first ground surface pathway is parallel to at least a portion of the second ground surface pathway: comparing a sum of half of a wingspan of the first intruder aircraft and half of a wingspan of the aircraft to a distance between a first centerline of the first ground surface pathway and a second centerline of the second ground surface pathway; and issuing a potential wingtip collision alert for display on a display device of the aircraft based on the comparison.

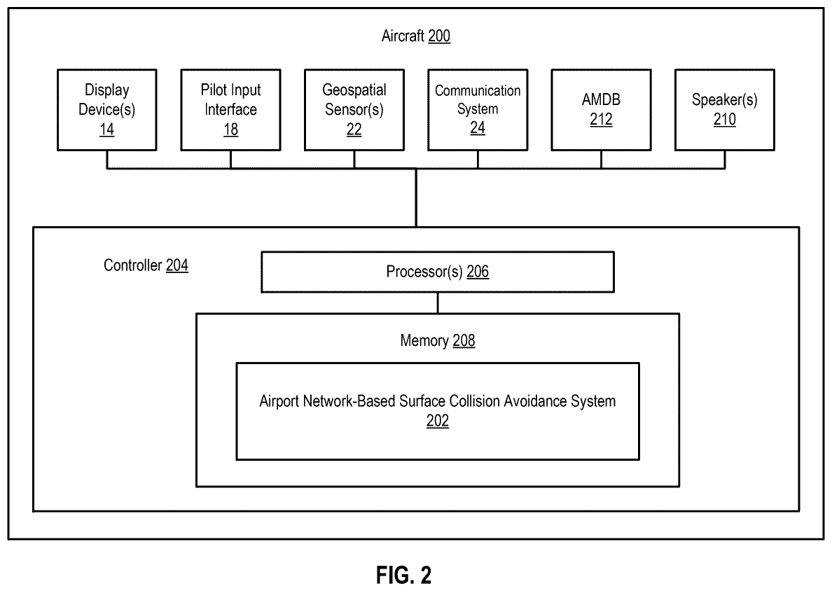

Referring to FIG. 2, a block diagram representation of an aircraft 200 including an airport network-based surface collision avoidance system 202 in accordance with at least one embodiment is shown. In various embodiments, the configuration of the aircraft 200 is similar to the configuration of platform 5 described with reference to FIG. 1. The aircraft 200 includes a controller 204. The controller 204 includes at least one processor 206 and at least one memory 208. The at least one memory 208 includes the airport network-based surface collision avoidance system 202. In various embodiments, the controller 204 may include additional components that facilitate operation of the controller 204.

The controller 204 is configured to be communicatively coupled to one or more display devices 14, a pilot input interface 18, one or more geospatial sensors 22, a communication circuit 24, an airport moving database (AMDB) 212, and one or more speakers 210. The communication circuit 24 may also be referred to as a communication system 24. The operation of the airport network-based surface collision avoidance system 202 will be described in further detail below.

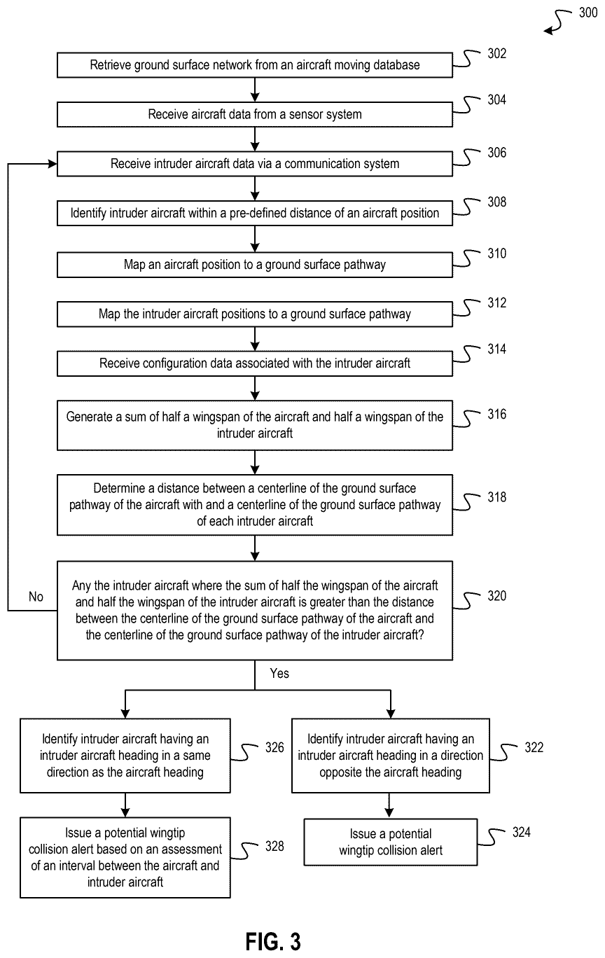

Referring to FIG. 3 a flowchart representation of a method 300 of implementing airport network-based collision avoidance in accordance with at least one embodiment is shown. The method 300 will be described with reference to an exemplary implementation of an airport network-based surface collision avoidance system 202. As can be appreciated in light of the disclosure, the order of operation within the method 300 is not limited to the sequential execution as illustrated in FIG. 3 but may be performed in one or more varying orders as applicable and in accordance with the present disclosure.

At 302, the airport network-based surface collision avoidance system 202 retrieves a ground surface network for an airport from an AMDB 212. The ground surface network for the airport includes a plurality of ground surface pathways. The ground surface network includes taxiways, runway segments, nodes, and intersections between the taxiways and the runways at the airport. In at least one embodiment, the AMDB 212 is configured to store the taxiways, the runway segments, the nodes, and the intersections between taxiways and runways for the airport. The airport network-based surface collision avoidance system 202 is configured to retrieve the taxiways, runway segments, nodes, and intersections between taxiways and runways for the airport and construct the ground surface network for the airport. In at least one embodiment, the AMDB 212 is configured to store the ground surface network for the airport. The airport network-based surface collision avoidance system 202 is configured to retrieve the ground surface network for the airport from the AMDB 212.

At 304, the airport network-based surface collision avoidance system 202 receives aircraft data for the aircraft 200 from geospatial sensor(s) 22 of the aircraft 200. In at least one embodiment, the aircraft data includes an aircraft position, an aircraft groundspeed, and an aircraft heading.

At 306, the airport network-based surface collision avoidance system 202 receives intruder aircraft data associated with a plurality of intruder aircraft via a communication system 34 of the aircraft 200. In at least one embodiment, the airport network-based surface collision avoidance system 202 receives the intruder aircraft data associated with the plurality of intruder aircraft from an automatic dependent surveillance-broadcast (ADS-B) system via the communication system 34. In at least one embodiment, the received intruder aircraft data for each intruder aircraft includes an intruder aircraft position, an intruder aircraft groundspeed, and an intruder aircraft identifier. In at least one embodiment, the intruder aircraft data received for each intruder aircraft includes the intruder aircraft position, the intruder aircraft groundspeed, the intruder aircraft identifier, and an intruder aircraft heading. In at least one embodiment, the intruder aircraft identifier of an intruder aircraft is a tail-number of the intruder aircraft.

At 308, the airport network-based surface collision avoidance system 202 identifies the intruder aircraft from the plurality of intruder aircraft within a pre-defined distance of the aircraft 200 based on the intruder aircraft positions of each of the intruder aircraft. In at least one embodiment, the airport network-based surface collision avoidance system 202 maintains a list of intruder aircraft within the pre-defined distance of the aircraft 200 and monitors the intruder data for each of the intruder aircraft on the list of intruder aircraft as an intruder aircraft on the list of intruder aircraft that may pose a potential wingtip collision risk to the aircraft 200.

At 310, the airport network-based surface collision avoidance system 202 maps the aircraft 200 to a ground surface pathway of the ground surface network of the airport. In at least one embodiment, the airport network-based surface collision avoidance system 202 maps the aircraft 200 to the ground surface pathway of the ground surface network of the airport based on the aircraft position of the aircraft 200.

At 312, the airport network-based surface collision avoidance system 202 maps each of the intruder aircraft on the list of intruder aircraft to ground surface pathways of the ground surface network. In at least one embodiment, the airport network-based surface collision avoidance system 202 maps each of the intruder aircraft on the list of intruder aircraft to ground surface pathways of the ground surface network of the airport based on the intruder aircraft positions associated with each of the intruder aircraft on the list of intruder aircraft.

At 314, the airport network-based surface collision avoidance system 202 receives configuration data associated with each of the intruder aircraft on the list of the intruder aircraft. In at least one embodiment, the airport network-based surface collision avoidance system 202 transmits a request to a remote system for configuration data associated with each of the intruder aircraft on the list of intruder aircraft. In at least one embodiment, the request includes the intruder aircraft identifier for each of the intruder aircraft on the list of intruder aircraft. In at least one embodiment, the intruder aircraft identifier for each of the intruder aircraft is the tail-number for that intruder aircraft. In at least one embodiment, the remote system is a cloud-based system. The list of intruder aircraft includes intruder aircraft that are traveling on ground surface pathway that is parallel to the ground surface pathway that the aircraft 200 is traveling on in the ground surface network. In at least one embodiment, a predefined tolerance is used to identify whether the ground surface pathways of the intruder aircraft are parallel to the ground surface pathway of the aircraft.

The remote system transmits the configuration data for each of the intruder aircraft on the list of intruder aircraft to the airport network-based surface collision avoidance system 202 in response to the request. In at least one embodiment, the configuration data includes a model associated with each of the intruder aircraft. The airport network-based surface collision avoidance system 202 is configured to store a wingspan associated with different models of aircraft. The airport network-based surface collision avoidance system 202 is configured to retrieve the wingspan for each of the intruder aircraft on the list of intruder aircraft. In at least one embodiment, the configuration data received from the remote system includes the wingspan of each intruder aircraft on the list of intruder aircraft. The airport network-based surface collision avoidance system 202 receives the wingspan for each of the intruder aircraft on the list of intruder aircraft from the remote system.

At 316, the airport network-based surface collision avoidance system 202 generates a sum of half a wingspan of the aircraft 200 and half a wingspan of each intruder aircraft on the list of intruder aircraft. In at least one embodiment, the airport network-based surface collision avoidance system 202 is configured to store the wingspan of the aircraft 200.

At 318, the airport network-based surface collision avoidance system 202 determines a distance between a centerline of the ground surface pathway of the aircraft 200 and a centerline of the ground surface pathway of each of the intruder aircraft on the list of intruder aircraft. In at least one embodiment, the airport network-based surface collision avoidance system 202 determines a shortest distance between the centerline of the ground surface pathway of the aircraft 200 and the centerline of the ground surface pathway of each of the intruder aircraft on the list of intruder aircraft.

At 320, the airport network-based surface collision avoidance system 202 determines whether there are any intruder aircraft on the list of intruder aircraft where the sum of half the wingspan of the aircraft 200 and half the wingspan of the intruder aircraft is greater than the distance between the centerline of the ground surface pathway of the aircraft 200 and the ground surface pathway of the intruder aircraft. In at least one embodiment, the airport network-based surface collision avoidance system 202 determines whether there are any intruder aircraft on the list of intruder aircraft where the sum of half the wingspan of the aircraft 200 and half the wingspan of the intruder aircraft is greater than a shortest distance between the centerline of the ground surface pathway of the aircraft 200 and the ground surface pathway of the intruder aircraft.

If the airport network-based surface collision avoidance system 202 determines that there are no intruder aircraft on the list of intruder aircraft where the sum of half the wingspan of the aircraft 200 and half the wingspan of the intruder aircraft is greater than the distance between the centerline of the ground surface pathway of the aircraft 200 and the ground surface pathway of the intruder aircraft, the method 300 returns to 306.

In at least one embodiment, if the airport network-based surface collision avoidance system 202 determines that there are no intruder aircraft on the list of intruder aircraft where the sum of half the wingspan of the aircraft 200 and half the wingspan of the intruder aircraft is greater than the shortest distance between the centerline of the ground surface pathway of the aircraft 200 and the ground surface pathway of the intruder aircraft, the method 300 returns to 306.

If the airport network-based surface collision avoidance system 202 determines that there is at least one intruder aircraft on the list of intruder aircraft where the sum of half the wingspan of the aircraft 200 and half the wingspan of the intruder aircraft is greater than the distance between the centerline of the ground surface pathway of the aircraft 200 and the ground surface pathway of the intruder aircraft, the method 300 proceeds to 322 and 324. When the sum of half the wingspan of the aircraft 200 and half the wingspan of an intruder aircraft is greater than the distance between the centerline of the ground surface pathway of the aircraft 200 and the ground surface pathway of that intruder aircraft, there may be a risk of a potential wingtip collision between the aircraft 200 and that intruder aircraft travelling on parallel ground surface pathways.

In at least one embodiment, if the airport network-based surface collision avoidance system 202 determines that there is at least one intruder aircraft on the list of intruder aircraft where the sum of half the wingspan of the aircraft 200 and half the wingspan of the intruder aircraft is greater than the shortest distance between the centerline of the ground surface pathway of the aircraft 200 and the ground surface pathway of the intruder aircraft, the method 300 proceeds to 322 and 324. When the sum of half the wingspan of the aircraft 200 and half the wingspan of an intruder aircraft is greater than the shortest distance between the centerline of the ground surface pathway of the aircraft 200 and the ground surface pathway of that intruder aircraft, there may be a risk of a potential wingtip collision between the aircraft 200 and that intruder aircraft.

At 322, the airport network-based surface collision avoidance system 202 identifies any intruder aircraft having an intruder aircraft heading in a direction that is opposite an aircraft heading of the aircraft 200 from the intruder aircraft identified in 320. In at least one embodiment, the intruder aircraft heading is received from the ADS-B system at the communication system 24 of the aircraft 200. In at least one embodiment, aircraft traffic on each ground surface pathway at the airport travels in a specific traffic direction. The airport network-based surface collision avoidance system 202 determines an intruder aircraft heading of an intruder aircraft based on traffic direction of the ground surface pathway that the intruder aircraft has been mapped to on the ground surface network of the airport.

If the aircraft 200 and an intruder aircraft are traveling in opposite directions on parallel ground surface pathways, the wingtip of the aircraft 200 will eventually make contact with the wingtip of that intruder aircraft as the aircraft 200 and the intruder aircraft approach each other if the aircraft 200 fails to implement wingtip collision avoidance maneuvers. At 324, the airport network-based surface collision avoidance system 202 issues a potential wingtip collision alert for display on a display device 14 of the aircraft 200. In at least one embodiment, the airport network-based surface collision avoidance system 202 issues an aural potential wingtip collision alert for generation via a speaker(s) 210 of the aircraft 200. The potential wingtip collision alert enables the pilot to implement wingtip collision avoidance maneuvers to avoid a wingtip collision between the wingtip of the aircraft 200 and the wingtip of the intruder aircraft.

In at least one embodiment, the airport network-based surface collision avoidance system 202 is configured to receive the aircraft data from the at least one geospatial sensor of the aircraft 200. The aircraft data includes the aircraft position, the aircraft groundspeed, and the aircraft heading. The airport network-based surface collision avoidance system 202 is configured to receive the intruder aircraft data of the intruder aircraft. The intruder aircraft data includes the intruder aircraft position, the intruder aircraft groundspeed, and the intruder aircraft heading. The airport network-based surface collision avoidance system 202 is configured to determine potential wingtip collision data based on the aircraft data and the intruder aircraft data. The potential wingtip collision data includes, but is not limited to, a potential wingtip collision location on the ground surface pathway that the aircraft 200 is traveling on, a potential time to the wingtip collision. The airport network-based surface collision avoidance system 202 is configured to generate the potential wingtip collision data for display on the display device 14 of the aircraft 200.

At 326, the airport network-based surface collision avoidance system 202 identifies any intruder aircraft has an intruder aircraft heading that is a same direction as the aircraft heading of the aircraft 200 from the intruder aircraft identified in 320. In at least one embodiment, the intruder aircraft heading is received from the ADS-B system at the communication system 24 of the aircraft 200. In at least one embodiment, aircraft traffic on each ground surface pathway at the airport travels in a specific traffic direction. The airport network-based surface collision avoidance system 202 determines an intruder aircraft heading of an intruder aircraft based on traffic direction of the ground surface pathway that the intruder aircraft has been mapped to on the ground surface network of the airport.

If the aircraft 200 and an intruder aircraft are traveling in same direction, the airport network-based surface collision avoidance system 202 determines an interval distance between the aircraft 200 and the intruder aircraft. The interval distance is either the distance that the aircraft 200 is traveling on a ground surface pathway behind the intruder aircraft traveling on a parallel ground surface pathway or the distance that the aircraft 200 is traveling on a ground surface pathway in front of the intruder aircraft traveling on a parallel ground surface pathway.

The airport network-based surface collision avoidance system 202 is configured to receive the aircraft data from the at least one geospatial sensor of the aircraft 200. The aircraft data includes the aircraft position, the aircraft groundspeed, and the aircraft heading. The airport network-based surface collision avoidance system 202 is configured to receive the intruder aircraft data of the intruder aircraft. The intruder aircraft data includes the intruder aircraft position, the intruder aircraft groundspeed, and the intruder aircraft heading. The airport network-based surface collision avoidance system 202 determines the interval distance between the aircraft 200 and the intruder aircraft based on the aircraft data and the interval aircraft data. The airport network-based surface collision avoidance system 202 determines whether there is a potential wingtip collision risk based on the aircraft data, the intruder aircraft data and the interval distance. For example, if the aircraft 200 is traveling on a ground surface pathway behind an intruder aircraft traveling on a parallel ground surface pathway at an aircraft groundspeed that is greater than the intruder aircraft groundspeed, there is a potential wingtip collision risk.

At 324, the airport network-based surface collision avoidance system 202 issues a potential wingtip collision alert for display on a display device 14 of the aircraft 200. In at least one embodiment, the airport network-based surface collision avoidance system 202 issues an aural potential wingtip collision alert for generation via a speaker(s) 210 of the aircraft 200. The potential wingtip collision alert enables the pilot to implement wingtip collision avoidance maneuvers to avoid a wingtip collision between the wingtip of the aircraft 200 and the wingtip of the intruder aircraft.

At 328, the airport network-based surface collision avoidance system 202 is configured to issue a potential wingtip collision alert for display on the display device 14 of the aircraft based on an assessment of the interval distance between the aircraft 200 and the intruder aircraft, the aircraft position, and the aircraft groundspeed, the intruder aircraft position, and the intruder aircraft groundspeed. The airport network-based surface collision avoidance system 202 issues a potential wingtip collision alert for display on a display device 14 of the aircraft 200. In at least one embodiment, the airport network-based surface collision avoidance system 202 issues an aural potential wingtip collision alert for generation via a speaker(s) 210 of the aircraft 200. The potential wingtip collision alert enables the pilot to implement wingtip collision avoidance maneuvers to avoid a wingtip collision between the wingtip of the aircraft 200 and the wingtip of the intruder aircraft.

In at least one embodiment, the airport network-based surface collision avoidance system 202 is configured to determine potential wingtip collision data based on the aircraft data and the intruder aircraft data. The potential wingtip collision data includes, but is not limited to, a potential wingtip collision location on the ground surface pathway that the aircraft 200 is traveling on, a potential time to the wingtip collision. The airport network-based surface collision avoidance system 202 is configured to generate the potential wingtip collision data for display on the display device 14 of the aircraft 200.

While the operation of the airport network-based surface collision avoidance system 202 has been described with reference to an aircraft 200 and an intruder aircraft traveling on parallel ground surface pathways, in alternative embodiments, the method 300 may be implemented in scenarios where a ground surface pathway of the aircraft 200 and a ground surface pathway of the intruder aircraft intersect. In at least one embodiment, the intruder aircraft position is mapped to a ground surface pathway and the aircraft position is mapped to a ground surface pathway. The ground surface network includes both ground surface pathways. Based on a determination that the ground surface pathway of the intruder aircraft intersects the ground surface pathway of the aircraft 200, the sum of half of the wingspan of the first intruder aircraft and half of the wingspan of the aircraft 200 is compared to a distance between a centerline of the ground surface pathway of the aircraft 200 and a centerline of the ground surface pathway of the intruder aircraft. A potential wingtip collision alert is issued for display on a display device of the aircraft 200 based on the comparison.

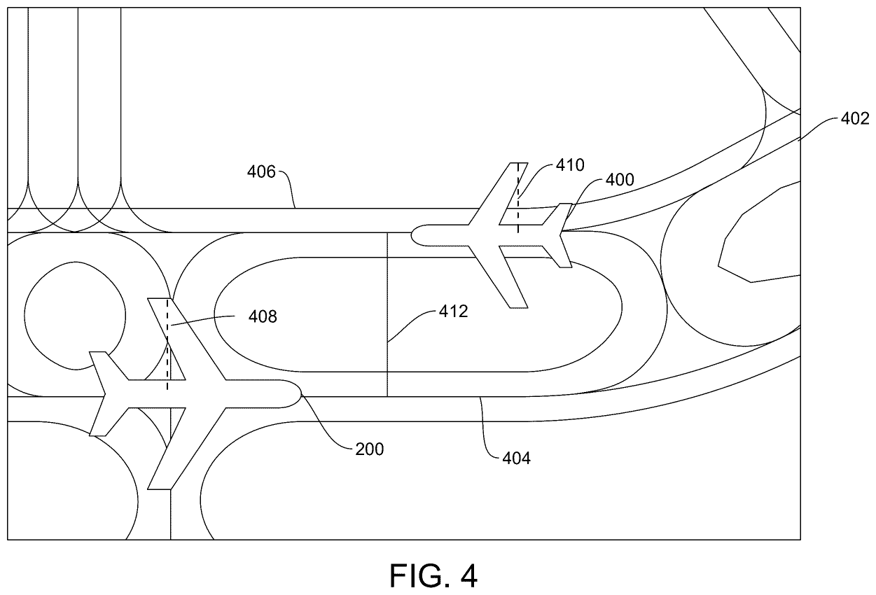

Referring to FIG. 4, an exemplary diagram of an aircraft 200 and an intruder aircraft 400 mapped to a ground surface network 402 of an airport in accordance with an embodiment is shown. The airport network-based surface collision avoidance system 202 retrieved the ground surface network 402 for the airport from an AMDB 212 onboard the aircraft 200. A portion of the retrieved ground surface network 402 is shown. The airport network-based surface collision avoidance system 202 received an aircraft position of the aircraft 200 from the geospatial sensor 22 of the aircraft 200 and an intruder aircraft position of the intruder aircraft 400 from an ADS-B system via a communication system 24 of the aircraft 200. The airport network-based surface collision avoidance system 202 determined that the intruder aircraft 400 was within a pre-defined distance of the aircraft position of the aircraft 200 and added the intruder aircraft to a list of intruder aircraft that could pose a potential risk of a wingtip collision with the aircraft 200.

The airport network-based surface collision avoidance system 202 mapped the aircraft position of the aircraft 200 to a ground surface pathway 404 of the ground surface network 402 and mapped the intruder aircraft position of the intruder aircraft 400 to a ground surface pathway 406 of the ground surface network 402. The ground surface pathway 404 of the aircraft 200 is parallel to the ground surface pathway 406 of the intruder aircraft 400.

The airport network-based surface collision avoidance system 202 received the intruder aircraft identifier from the ADS-B system via the communication system 24. The intruder aircraft identifier is a tail-number of the intruder aircraft 400. The airport network-based surface collision avoidance system 202 requested configuration data associated with the intruder aircraft 400 from a remote system and received the configuration data from the remote system. The configuration data included a wingspan of the intruder aircraft 400. The airport network-based surface collision avoidance system 202 stores the wingspan of the aircraft 200.

The airport network-based surface collision avoidance system 202 generated a sum of half the wingspan 408 of the aircraft 200 and half the wingspan 410 of the intruder aircraft 400. The airport network-based surface collision avoidance system 202 determined a distance 412 between a centerline of ground surface pathway 404 of the aircraft 200 and a centerline of the ground surface pathway 406 of the intruder aircraft 400. The airport network-based surface collision avoidance system 202 determined that the sum of half the wingspans 408, 410 was greater than the distance 412 between the centerline of ground surface pathway 404 of the aircraft 200 and the centerline of the ground surface pathway 406 of the intruder aircraft 400 and that the intruder aircraft has an intruder aircraft heading in an opposite direction compared to the aircraft heading of the aircraft 200.

Since the aircraft 200 and the intruder aircraft 400 are traveling in opposite directions on parallel ground surface pathways 404, 406, and the sum of half the wingspans 408, 410 is greater than the distance 412 between the centerlines of ground surface pathway 404, 406, the wingtip of the aircraft 200 will eventually make contact with the wingtip of that intruder aircraft 400 as the aircraft 200 and the intruder aircraft approach each other if the pilot of the aircraft 200 fails to implement wingtip collision avoidance maneuvers. The airport network-based surface collision avoidance system 202 issues a potential wingtip collision alert for display on a display device 14 of the aircraft 200. The potential wingtip collision alert enables the pilot to implement wingtip collision avoidance maneuvers to avoid a wingtip collision between the wingtip of the aircraft 200 and the wingtip of the intruder aircraft 400.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An airport network-based surface collision avoidance system comprising:
at least one processor;
and at least one memory communicatively coupled to the at least one processor, the at least one memory comprising instructions that upon execution by the at least one processor, cause the at least one processor to:
receive aircraft data associated with an aircraft from at least one geospatial sensor of the aircraft, the aircraft data comprising an aircraft position;
receive first intruder aircraft data associated with a first intruder aircraft via a communication system of the aircraft, the first intruder aircraft data comprising a first intruder aircraft position;
retrieve a ground surface network from an aircraft moving database (AMDB) of the aircraft, the ground surface network comprising a plurality of ground surface pathways;
map the first intruder aircraft position to a first ground surface pathway and the aircraft position to a second ground surface pathway, the plurality of ground surface pathways comprising the first and second ground surface pathways; and
based on a determination that at least a portion of the first ground surface pathway is parallel to at least a portion of the second ground surface pathway:
compare a sum of half of a wingspan of the first intruder aircraft and half of a wingspan of the aircraft to a distance between a first centerline of the first ground surface pathway and a second centerline of the second ground surface pathway; and
issue a potential wingtip collision alert for display on a display device of the aircraft based on the comparison.

2. The system of claim 1, wherein, the at least one memory further comprises instructions that upon execution by the at least one processor, cause the at least one processor to receive the first intruder aircraft data from an automatic dependent surveillance-broadcast (ADS-B) system at the communication system.

3. The system of claim 1, wherein, the at least one memory further comprises instructions that upon execution by the at least one processor, cause the at least one processor to:
receive the aircraft data from the at least one geospatial sensor, the aircraft data comprising the aircraft position, an aircraft groundspeed, and an aircraft heading;
receive the first intruder aircraft data via the communication system, the first intruder aircraft data comprising the first intruder aircraft position, a first intruder aircraft groundspeed, and a first intruder aircraft heading;
determine potential wingtip collision data based on the aircraft data and the first intruder aircraft data, the potential wingtip collision data comprising at least one of a potential time to wingtip collision and a potential wingtip collision location on the second ground surface pathway; and
generate the potential wingtip collision data for display on the display device.

4. The system of claim 1, wherein, the at least one memory further comprises instructions that upon execution by the at least one processor, cause the at least one processor to:
receive the first intruder aircraft data associated with the first intruder aircraft via the communication system, the first intruder aircraft data comprising a first intruder aircraft identifier;
transmit a request to a remote system for configuration data associated with the first intruder aircraft identifier via the communication system; and
receive the configuration data associated with the first intruder aircraft identifier from the remote system via the communication system, the configuration data comprising the wingspan of the first intruder aircraft.

5. The system of claim 1, wherein, the at least one memory further comprises instructions that upon execution by the at least one processor, cause the at least one processor to:
receive a plurality of intruder aircraft data associated with a plurality of intruder aircraft via the communication system, each of the plurality of intruder aircraft data comprising an intruder aircraft position of an associated one of the plurality of intruder aircraft; and
identify at least one intruder aircraft from the plurality of intruder aircraft having an associated intruder aircraft position within a pre-defined distance of the aircraft position, the identified at least one intruder aircraft including the first intruder aircraft.

6. The system of claim 1, wherein, the at least one memory further comprises instructions that upon execution by the at least one processor, cause the at least one processor to:
receive the aircraft data from the at least one geospatial system, the aircraft data comprising the aircraft position, an aircraft groundspeed, and an aircraft heading;
receive the first intruder aircraft data via the communication system, the first intruder aircraft data comprising the first intruder aircraft position, a first intruder aircraft groundspeed, and a first intruder aircraft heading; and
based on a determination that the aircraft heading is the same the first intruder aircraft heading;
identify an interval distance between the aircraft and the first intruder aircraft based on the aircraft data and the intruder aircraft data;
determine whether there is a potential wingtip collision risk based on the aircraft data, the first intruder aircraft data and the interval distance; and
issue the potential wingtip collision alert for display on the display device of the aircraft based on the determination.

7. The system of claim 1, wherein, the at least one memory further comprises instructions that upon execution by the at least one processor, cause the at least one processor to:
receive the aircraft data from the at least one geospatial sensor, the aircraft data comprising the aircraft position, an aircraft groundspeed, and an aircraft heading;
receive the first intruder aircraft data via the communication system, the first intruder aircraft data comprising the first intruder aircraft position and a first intruder aircraft groundspeed;
determine a first intruder aircraft heading based on a traffic direction of the first ground surface pathway;
based on a determination that the aircraft and the first intruder aircraft are travelling in a same direction based on the aircraft heading and the traffic direction of the first ground surface pathway;
identify an interval distance between the aircraft and the first intruder aircraft based on the aircraft data, the first intruder aircraft position, and the first intruder aircraft groundspeed;
determine whether there is a potential wingtip collision risk based on the aircraft data, the first intruder aircraft data and the interval distance; and
issue the potential wingtip collision alert for display on the display device of the aircraft based on the determination.

8. The system of claim 1, wherein, the at least one memory further comprises instructions that upon execution by the at least one processor, cause the at least one processor to issue an aural potential wingtip collision alert based on the comparison of the sum of the half of the wingspan of the first intruder aircraft and the half of the wingspan of the aircraft to the distance between the first centerline of the first ground surface pathway and the second centerline of the second ground surface pathway.

9. The system of claim 1, wherein, the at least one memory further comprises instructions that upon execution by the at least one processor, cause the at least one processor to:
compare the sum of the half of the wingspan of the first intruder aircraft and the half of the wingspan of the aircraft to a shortest distance between the first centerline of the first ground surface pathway and the second centerline of the second ground surface pathway; and
issue the potential collision wingtip alert for display on the display device of the aircraft based on the comparison.

10. An aircraft including an airport network-based surface collision avoidance system comprising:
at least one geospatial sensor configured to generated aircraft data associated with the aircraft;
a communication system;
an aircraft moving database (AMDB) comprising a ground surface network associated with an airport, the ground surface network comprising a plurality of ground surface pathways at the airport;
a display device; and
a controller configured to be communicatively coupled to the at least one geospatial sensor, the communication system, the AMDB; and the display device, the controller being configured to:
receive first intruder aircraft data associated with a first intruder aircraft via the communication system, the first intruder aircraft data comprising a first intruder aircraft position;
receive the aircraft data from the at least one geospatial sensor, the aircraft data comprising an aircraft position;
retrieve the ground surface network from the AMDB;
map the first intruder aircraft position to a first ground surface pathway and the aircraft position to a second ground surface pathway, the plurality of ground surface pathways comprising the first and second ground surface pathways; and
based on a determination that at least a portion of the first ground surface pathway is parallel to at least a portion of the second ground surface pathway:
compare a sum of half of a wingspan of the first intruder aircraft and half of a wingspan of the aircraft to a distance between a first centerline of the first ground surface pathway and a second centerline of the second ground surface pathway; and
issue a potential wingtip collision alert for display on the display device of the aircraft based on the comparison.

11. The system of claim 10, wherein the controller is further configured to receive the first intruder aircraft data from an automatic dependent surveillance-broadcast (ADS-B) system at the communication system.

12. The system of claim 10, wherein the controller is further configured to:
receive the aircraft data from the at least one geospatial sensor, the aircraft data comprising the aircraft position, an aircraft groundspeed, and an aircraft heading;
receive the first intruder aircraft data via the communication system, the first intruder aircraft data comprising the first intruder aircraft position, a first intruder aircraft groundspeed, and a first intruder aircraft heading;
determine potential wingtip collision data based on the aircraft data and the first intruder aircraft data, the potential wingtip collision data comprising at least one of a potential time to wingtip collision and a potential wingtip collision location on the second ground surface pathway; and
generate the potential wingtip collision data for display on the display device.

13. The system of claim 10, wherein the controller is further configured to:
receive the first intruder aircraft data associated with the first intruder aircraft via the communication system, the first intruder aircraft data comprising a first intruder aircraft identifier;
issue a request to a remote system for configuration data associated with the first intruder aircraft identifier via the communication system; and
receive the configuration data associated with the first intruder aircraft identifier from the remote system via the communication system, the configuration data comprising the wingspan of the first intruder aircraft.

14. The system of claim 10, wherein the controller is further configured to:
receive a plurality of intruder aircraft data associated with a plurality of intruder aircraft via the communication system, each of the plurality of intruder aircraft data comprising an intruder aircraft position of an associated one of the plurality of intruder aircraft; and
identify at least one intruder aircraft from the plurality of intruder aircraft having an associated intruder aircraft position within a pre-defined distance of the aircraft position, the identified at least one intruder aircraft including the first intruder aircraft.

15. The system of claim 10, wherein the controller is further configured to:
receive the aircraft data from the at least one geospatial sensor, the aircraft data comprising the aircraft position, an aircraft groundspeed, and an aircraft heading;
receive the first intruder aircraft data via the communication system, the first intruder aircraft data comprising the first intruder aircraft position, a first intruder aircraft groundspeed, and a first intruder aircraft heading; and
based on a determination that the aircraft heading is the same the first intruder aircraft heading;
identify an interval distance between the aircraft and the first intruder aircraft based on the aircraft data and the intruder aircraft data;
determine whether there is a potential wingtip collision risk based on the aircraft data, the first intruder aircraft data, and the interval distance; and
issue the potential wingtip collision alert for display on the display device of the aircraft based on the determination.

16. The system of claim 10, wherein the controller is further configured to:
receive the aircraft data from the at least one geospatial sensor, the aircraft data comprising the aircraft position, an aircraft groundspeed, and an aircraft heading;
receive the first intruder aircraft data via the communication system, the first intruder aircraft data comprising the first intruder aircraft position, a first intruder aircraft groundspeed;
determine a first intruder aircraft heading based on a traffic direction of the first ground surface pathway;
based on a determination that the aircraft and the first intruder aircraft are travelling in a same direction based on the aircraft heading and the traffic direction of the first ground surface pathway;
identify an interval distance between the aircraft and the first intruder aircraft based on the aircraft data, the first intruder aircraft position and the first intruder aircraft groundspeed;
determine whether there is a potential wingtip collision risk based on the aircraft data, the first intruder aircraft data, and the interval distance; and
issue the potential wingtip collision alert for display on the display device of the aircraft based on the determination.

17. The system of claim 10, wherein the controller is further configured to issue an aural potential wingtip collision alert based on the comparison of the sum of the half of the wingspan of the first intruder aircraft and the half of the wingspan of the aircraft to the distance between the first centerline of the first ground surface pathway and the second centerline of the second ground surface pathway.

18. The system of claim 10, wherein the controller is further configured to:
compare the sum of half of the wingspan of the first intruder aircraft and half of the wingspan of the aircraft to a shortest distance between the first centerline of the first ground surface pathway and the second centerline of the second ground surface pathway; and
issue the potential collision wingtip alert for display on the display device of the aircraft based on the comparison.

19. A method for implementing an airport network-based surface collision avoidance comprising:
receiving aircraft data associated with an aircraft from at least one geospatial sensor of the aircraft, the aircraft data comprising an aircraft position;
receiving first intruder aircraft data associated with a first intruder aircraft via a communication system of the aircraft, the first intruder aircraft data comprising a first intruder aircraft position;
retrieving a ground surface network from an aircraft moving database (AMDB) of the aircraft, the ground surface network comprising a plurality of ground surface pathways;
mapping the first intruder aircraft position to a first ground surface pathway and the aircraft position to a second ground surface pathway, the plurality of ground surface pathways comprising the first and second ground surface pathways; and
based on a determination that at least a portion of the first ground surface pathway is parallel to at least a portion of the second ground surface pathway:
comparing a sum of half of a wingspan of the first intruder aircraft and half of a wingspan of the aircraft to a distance between a first centerline of the first ground surface pathway and a second centerline of the second ground surface pathway; and
issuing a potential wingtip collision alert for display on a display device of the aircraft based on the comparison.

20. The method of claim 19, further comprising:
mapping the first intruder aircraft position to a third ground surface pathway and the aircraft position to a fourth ground surface pathway, the plurality of ground surface pathways comprising the third and fourth ground surface pathways; and
based on a determination that the third ground surface pathway intersects the fourth ground surface pathway:
comparing the sum of half of the wingspan of the first intruder aircraft and half of the wingspan of the aircraft to a distance between a third centerline of the third ground surface pathway and a fourth centerline of the fourth ground surface pathway; and
issuing the potential wingtip collision alert for display on a display device of the aircraft based on the comparison.
